(19) United States
(12) Patent Application Publication
(10) Pub. No.: US 2026/0246981 A1
(43) Pub. Date: Aug. 20, 2026

(54) Dependent Context Model for Transform Types

(71) Applicant: Google LLC, Mountain View, CA (US)

(72) Inventors: Cheng Chen, Milpitas, CA (US); Jingning Han, Santa Clara, CA (US)

(21) Appl. No.: 18/992,814

(22) PCT Filed: Jul. 19, 2023
(86) PCT No.: PCT/US2023/028184

§ 371 Date: Jan. 9, 2025

Related U.S. Application Data
(60) Provisional application No. 63/390,609, filed on Jul. 19, 2022.

(51) Int. Cl. H04N 19/91; H04N 19/60

(52) U.S. Cl. CPC H04N 19/91; H04N 19/60

(57) ABSTRACT

Complexity in entropy coding a two-dimensional (2D) transform type for a block in image and video coding is reduced by reducing the number of symbols to fewer than the number of transform types. Signaling the 2D transform type involves splitting the 2D transform into two one-dimensional (1D) transform types that are signaled separately using a joint probability determined by the dependency of the second 1D transform type on the first 1D transform type.

### CROSS-REFERENCE TO RELATED APPLICATION

This application claims priority to U.S. Provisional Patent Application No. 63/390,609, filed Jul. 19, 2022, which is incorporated herein in its entirety by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including lossy and lossless compression techniques. Lossless compression techniques include entropy coding.

### SUMMARY

Probability estimation is used for entropy coding, particularly with context-based entropy coding for lossless compression. Efficiency of the entropy coding depends on the accuracy of the probability estimation. Entropy coding, particularly for hardware implementations, is relatively complex.

The teachings herein describe different methods and apparatuses for reducing the complexity of entropy coding transform types while maintaining the accuracy of the probability estimation. It does this by introducing a dependent context model for probability estimation when entropy coding a two-dimensional transform type.

According to an aspect of the teaching herein, a method for entropy coding a two-dimensional (2D) transform type includes receiving a first one-dimensional (1D) transform type that forms the 2D transform type, entropy coding the first 1D transform type using context information, receiving a second 1D transform type that forms the 2D transform type, and entropy coding the second 1D transform type. Entropy coding the second 1D transform type is conditioned on the first 1D transform type.

In some implementations, the first 1D transform type is a 1D vertical transform type and the second 1D transform type is a 1D horizontal transform type.

In some implementations, the first 1D transform type is a 1D horizontal transform type and the second 1D transform type is a 1D vertical transform type.

In some implementations, the 2D transform type is one transform type of 16 available transform types, and a cardinality of symbols available for entropy coding each of the first 1D transform type and the second 1D transform type is 4.

In some implementations, entropy coding the first 1D transform type comprises entropy encoding a first symbol representing the first 1D transform type, and entropy coding the second 1D transform type comprises entropy encoding a second symbol representing the second 1D transform type. A software encoder may perform the entropy coding, or the entropy coding may be performed by a hardware encoder.

In some implementations, entropy coding the first 1D transform type comprises entropy decoding a first variable from an encoded bitstream representing the first 1D transform type, and entropy coding the second 1D transform type comprises entropy decoding a second variable from the encoded bitstream representing the second 1D transform type. A software decoder may perform the entropy coding, or the entropy coding may be performed by a hardware decoder.

In some implementations, the first 1D transform type is different from the second 1D transform type.

In some implementations, a probability of the 2D transform type is modeled as a joint probability of the first 1D transform type and the second 1D transform type. For example, the joint probability is equal to the sum of a probability of the first 1D transform type and a probability of the second 1D transform type conditioned on the first 1D transform type.

An apparatus for entropy coding a two-dimensional (2D) transform type according to any of the methods above is also described. The apparatus may be a hardware encoder or a hardware decoder. The apparatus may be a software encoder or a software decoder that includes a processor and a memory storing instructions that cause the processor to perform the methods and techniques described herein.

Aspects of this disclosure and variations thereof are disclosed in the following detailed description of the implementations, the appended claims, and the accompanying figures.

### BRIEF DESCRIPTION OF THE DRAWINGS

The description herein refers to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an example of an encoder.

FIG. 5 is a block diagram of an example of a decoder.

FIG. 6 is a flowchart diagram of a technique of entropy coding transform types using a dependent context model.

### DETAILED DESCRIPTION

Video compression schemes may include breaking respective images, or frames, into smaller portions, such as blocks, and generating an encoded bitstream using techniques to limit the information included for respective blocks thereof. The encoded bitstream can be decoded to re-create or reconstruct the source images from the limited information. The information may be limited by lossy coding, lossless coding, or some combination of lossy and lossless coding.

One type of lossless coding is entropy coding, where entropy is generally considered the degree of disorder or randomness in a system. Entropy coding compresses a sequence in an informationally efficient way. That is, a lower bound of the length of the compressed sequence is the entropy of the original sequence. An efficient algorithm for entropy coding desirably generates a code (e.g., in bits) whose length approaches the entropy. For a particular sequence of syntax elements, the entropy associated with the code may be defined as a function of the probability distribution of observations (e.g., symbols, values, outcomes, hypotheses, etc.) for the syntax elements over the sequence. Arithmetic coding can use the probability distribution to construct the code.

However, a codec does not receive a sequence together with the probability distribution. Instead, probability estimation may be used in video codecs to implement entropy coding. That is, the probability distribution of the observations may be estimated using one or more probability estimation models (also called probability or context models herein) that model the distribution occurring in an encoded bitstream so that the estimated probability distribution approaches the actual probability distribution. According to such technique, entropy coding can reduce the number of bits required to represent the input data to close to a theoretical minimum (i.e., the lower bound).

In practice, the actual reduction in the number of bits required to represent video data can be a function of the accuracy of the context model, the number of bits over which the coding is performed, and the computational accuracy of the (e.g., fixed-point) arithmetic used to perform the coding.

Accuracy is not the only desired goal in entropy coding. The number of symbols representing a single data type is relevant, such as the number of symbols representing a transform coefficient, a transform type, a prediction mode, etc. More symbols result in more complexity. For hardware implementations, for example, the complexity can result in the need for a greater die area, a higher cost, a slower speed, etc.

The teachings herein reduce the complexity in entropy coding a two-dimensional (2D) transform type for a block in image and video coding. It reduces the number of symbols to fewer than the number of transform types. The 2D transform type involves splitting the 2D transform into two one-dimensional (1D) transform types that are signaled separately. A dependent context model is used for the entropy coding that including a joint probability determined by the dependency of the second 1D transform type on the first 1D transform type.

Further details of a dependent context model for transform types are described herein first with reference to a system in which the teachings may be incorporated.

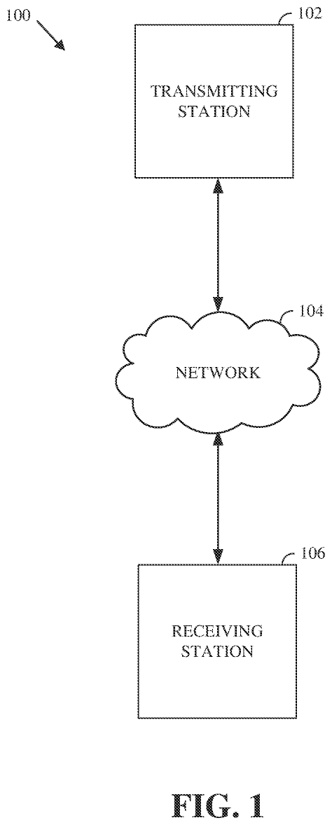

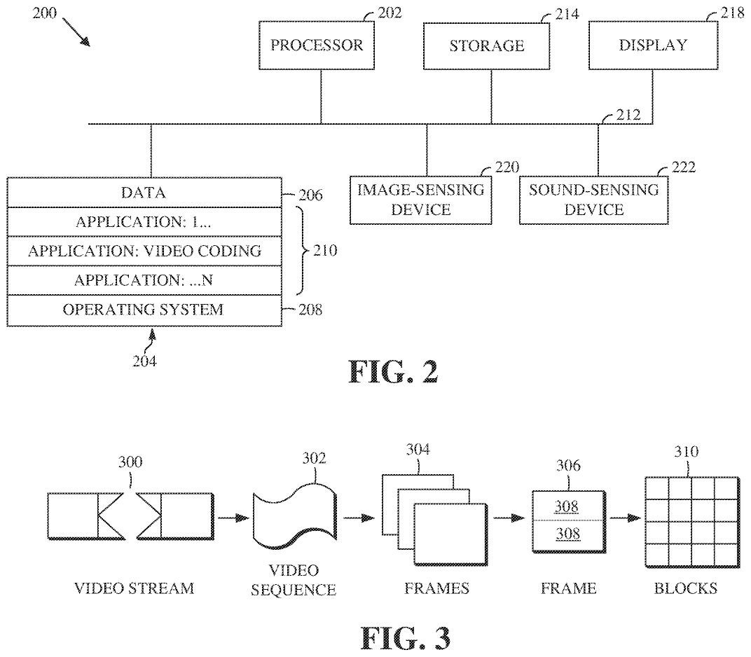

FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, such as a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data. Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random-access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into a single unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of a video stream 300 to be encoded and subsequently decoded. The video stream 300 includes a video sequence 302. At the next level, the video sequence 302 includes multiple adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

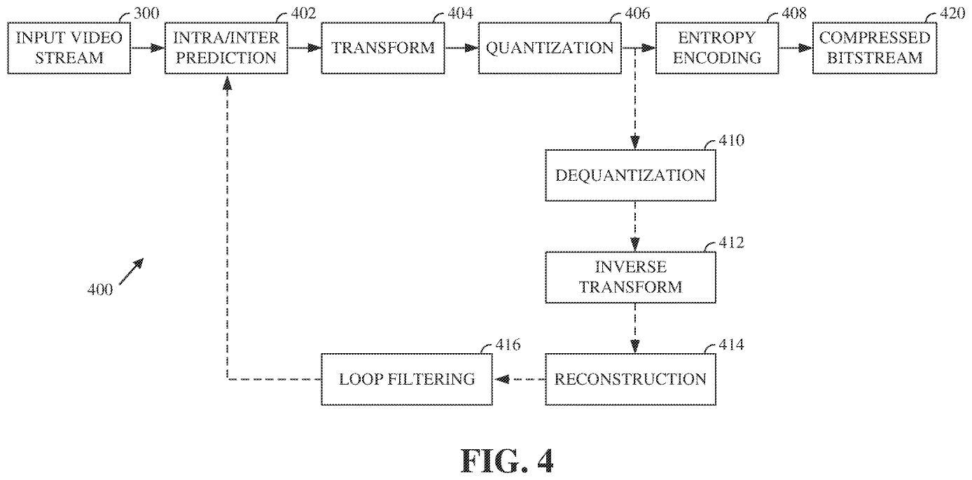

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

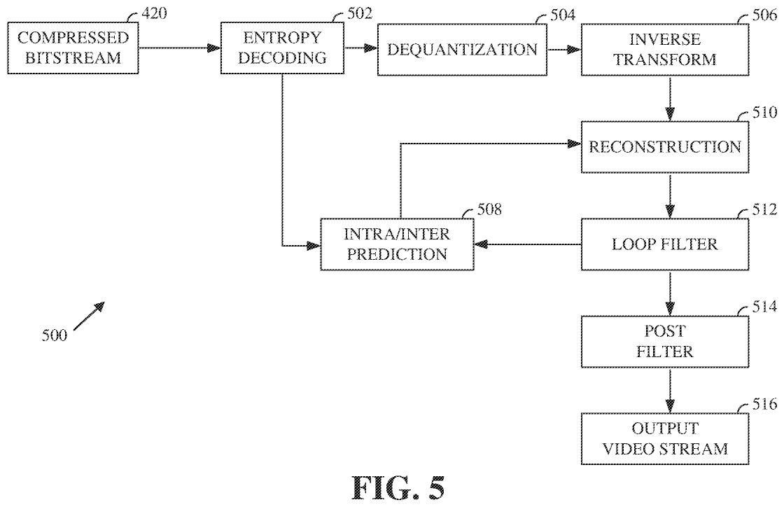

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, like the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

As can be discerned from the description of the encoder 400 and the decoder 500 above, bits are generally used for one of two things in an encoded video bitstream: either content prediction (e.g., inter mode/motion vector coding, intra prediction mode coding, etc.) or residual or coefficient coding (e.g., transform coefficients). Encoders may use techniques to decrease the bits spent on representing this data, including entropy coding. A decoder is informed of (or has available) a context model used to encode an entropy-coded video bitstream so the decoder can decode the video bitstream. Provided an initial state of the probability for each outcome (i.e., each symbol), the codec updates the probability model for each new observation.

For example, an M-ary symbol arithmetic coding method can be used to entropy code syntax elements. In some implementations, integer M∈[2, 16]. An M-ary random variable requires a table of M−1 entries to represent its probability model. The probability mass function (PMF) may be represented as equation (1).

$${\overline{P}}_{n} = [ {p}_{1} ( n ) , {p}_{2} ( n ) , … , {p}_{M} ( n ) ] \qquad ( 1 )$$

The cumulative distribution function (CDF) may be represented as equation (2).

$${\overline{C}}_{n} = [ {c}_{1} ( n ) , {c}_{2} ( n ) , … , {c}_{M - 1} ( n ) , 1 ] , \qquad ( 2 )$$

In each of these equations, n refers to the time variable.

The probability model uses a per symbol update. When a symbol is coded, a new outcome k∈{1, 2, . . . , M} is observed. The probability model is then updated according to equation (3).

$${\overline{P}}_{n} = {\overline{P}}_{n - 1} ( 1 - α ) + α {\overline{e}}_{k} , \qquad ( 3 )$$

In equation (3), ēₖ is an indicator vector whose k-th element is 1 and the rest are 0, and a is the update rate. This translates into an equivalent CDF update equation (4).

$${c}_{m} ( n ) = \{ \begin{matrix}{c}_{m} ( n - 1 ) \cdot ( 1 - α ) , m < k \\ {c}_{m} ( n - 1 ) + α \cdot ( 1 - {c}_{m} ( n - 1 ) ) , m \geq k\end{matrix} \qquad ( 4 )$$

The update rate is defined by equation (5), where count is the number of symbols coded at the time of the update.

$$α = \frac{1}{{2}^{3 + I ( count > 15 ) + I ( count > 31 ) + min ( {log}_{2} ( M ) , 2 )}} \qquad ( 5 )$$

Reducing complexity in entropy coding can be achieved by reducing the maximum supported symbol size. Instead of M∈[2, 16], for example, M∈[2, 8] would significantly reduce complexity. However, this is difficult to achieve when the number of choices for a syntax element is greater than 8.

For example, the number of symbols used to represent the syntax element 2D transform type for a block of an image or frame may be equal to the number of available 2D transform types. For example, there may be sixteen 2D transform types, and each 2D transform type may be represented by a separate symbol, such as a variable from 0 to 15 or some other symbols. In the examples herein, the sixteen 2D transform types are the permutation of different 1D transform types, for example four 1D transform types such as the Discrete Cosine Transform (DCT), the identity transform (IDX), the Asymmetric Discrete Sine Transform (ADST), and flipped ADST. By changing the technique for coding a transform type to signal the 1D transform types forming the 2D transform types, the number of symbols may be reduced.

In general, the 1D vertical and horizontal transform types may be modeled as separate random variables. That is, each 1D vertical transform type and 1D horizontal transform type in a sequence of syntax elements to be entropy coded has its own probability table, with its own probability updates. The random variable representing the transform type for the vertical direction may be represented by x in the below notation, while the random variable representing the transform type for the horizontal direction may be represented by y.

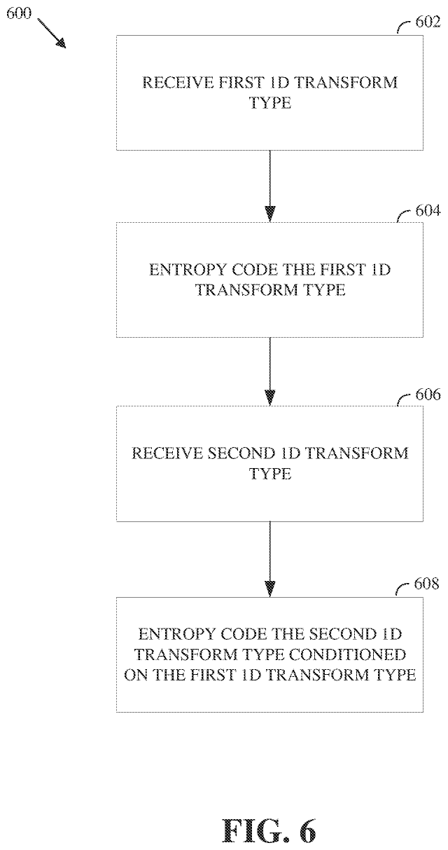

FIG. 6 is a flowchart diagram of a technique or process 600 of entropy coding transform types using a dependent context model. More specifically, FIG. 6 describes entropy coding a 2D transform type using a dependent context model.

The process 600 can be implemented, for example, as a software program that may be executed by computing devices such as the transmitting station 102 or the receiving station 106. The software program can include machine-readable instructions that may be stored in a memory such as the memory 204 or the secondary storage 214, and that, when executed by a processor, such as the processor 202, may cause the computing device to perform the process 600. The process 600 may be implemented in one or more stages of an encoder, such as the entropy encoding stage 408 of the encoder 400, or a decoder, such as the entropy decoding stage 502 of the decoder 500. The process 600 can be implemented using specialized hardware or firmware. Multiple processors, memories, or both, may be used. The process 600 may be repeated for blocks of an image, such as a still image or images that correspond to frames of a video sequence.

The transform type may be used for encoding at the transform stage 404, decoding at the inverse transform stage 506, or both, as described above. Entropy coding may encompass entropy encoding, entropy decoding, or both, because each of the encoder and decoder of a codec, such as the encoder 400 and decoder 500, separately maintains and uses a probability model, such as the probability model described above.

At operation 602, a first 1D transform type that forms the 2D transform type is received. For example, the first 1D transform type may be received as a variable received from an encoded bitstream, such as the compressed bitstream 420, at an entropy decoding stage 502. The first 1D transform type may be received as a symbol at an entropy encoding stage 408 for entropy coding the first 1D transform type.

At operation 604, the first 1D transform type is entropy coded. For example, the variable may be entropy decoded using context information according to the techniques described above, or the symbol may be entropy encoded using context information according to the techniques described above (for example, using the tables and the probability update described above). Possible context information may include the block size, the prediction mode, the block position, etc., or other variables relevant to the coding of the block.

At operation 606, a second 1D transform type that forms the 2D transform type is received. For example, the second 1D transform type may be received as a variable from an encoded bitstream, such as the compressed bitstream 420, at an entropy decoding stage 502. The second 1D transform type may be received as a symbol at an entropy encoding stage 408 for entropy coding the second 1D transform type.

At operation 608, the second 1D transform type is entropy coded. Entropy coding the second 1D transform type is conditioned on the first 1D transform type.

More specifically, the entropy cost of signaling a 2D transform type is the joint probability P(x, y|C), where C represents the context information. The joint probability may be decomposed into equation (6).

$$P ( x , y \vert C ) = P ( x \vert C ) + P ( y \vert x , C ) \qquad ( 6 )$$

That is, where the vertical transform type is signaled first (that is, the first 1D transform type is a 1D vertical transform type), the joint probability is equal to the sum of the probability P(x|C) of the 1D vertical transform type and the probability P(y|x, C) of the 1D horizontal transform type conditioned on the 1D vertical transform type (e.g., on the variable representing the 1D vertical transform type).

Similarly, if the horizontal transform type is signaled first, the joint probability may be decomposed into equation (7).

$$P ( x , y \vert C ) = P ( y \vert C ) + P ( x \vert y , C ) \qquad ( 7 )$$

That is, where the horizontal transform type is signaled first (that is, the first 1D transform type is a 1D horizontal transform type), the joint probability is equal to the sum of the probability P(y|C) of the 1D horizontal transform type and the probability P(x|y, C) of the 1D vertical transform type conditioned on the 1D horizontal transform type (e.g., on the variable representing the 1D horizontal transform type).

In either case, the probability of the 2D transform type is modeled as a joint probability of two 1D transform types that recognizes the dependency between the two 1D transform types. Instead of signaling one variable to represent the 2D transform type, two variables are signaled, where the first represents one (e.g., the vertical or horizontal) transform type and the second represents the other (e.g., the horizontal or vertical) transform type, conditioned on the value of the first variable. In this way—using the dependent context model—a neutral compression efficiency is achieved while reducing the number of symbols to be entropy coded from, in this example, sixteen to four. This design thus reduces the complexity of entropy coding, which is particularly desirable in hardware implementations.

As mentioned, the entropy coding can be entropy encoding such that the entropy encoded 1D transform types are included in an encoded bitstream (e.g., in a block or other header) for storage and/or transmission to a decoder. The entropy coding can be entropy decoding such that the entropy decoded 1D transform types are used for inverse transformation an encoded residual to reconstruct a block of the image.

The techniques described herein describe a dependent context model for transform types. Using the techniques, complexity of entropy coding can be reduced by reducing the number of symbols of transform types (e.g., from 16 to 4) by splitting the signaling of a 2D transform types into two 1D transform types without noticeable compression efficiency loss. This can reduce the cost of a hardware implementation.

For simplicity of explanation, the techniques herein may be depicted and described as a series of blocks, steps, or operations. However, the blocks, steps, or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. A method, comprising:
receiving a first one-dimensional (1D) transform type that forms a two-dimensional (2D) transform type;
entropy coding the first 1D transform type using context information;
receiving a second 1D transform type that forms the 2D transform type; and
entropy coding the second 1D transform type, wherein entropy coding the second 1D transform type is conditioned on the first 1D transform type.

2. The method of claim 1, wherein the first 1D transform type is a 1D vertical transform type and the second 1D transform type is a 1D horizontal transform type.

3. The method of claim 1, wherein the first 1D transform type is a 1D horizontal transform type and the second 1D transform type is a 1D vertical transform type.

4. The method of claim 1, wherein the 2D transform type is one transform type of 16 available transform types, and a cardinality of symbols available for entropy coding each of the first 1D transform type and the second 1D transform type is 4.

5. The method of claim 1, wherein entropy coding the first 1D transform type comprises entropy encoding a first symbol representing the first 1D transform type, and entropy coding the second 1D transform type comprises entropy encoding a second symbol representing the second 1D transform type.

6. The method of claim 5, wherein the entropy coding is performed by a hardware encoder.

7. The method of claim 1, wherein entropy coding the first 1D transform type comprises entropy decoding a first variable from an encoded bitstream representing the first 1D transform type, and entropy coding the second 1D transform type comprises entropy decoding a second variable from the encoded bitstream representing the second 1D transform type.

8. The method of claim 7, wherein the entropy coding is performed by a hardware decoder.

9. The method of claim 1, wherein the first 1D transform type is different from the second 1D transform type.

10. The method of claim 1, wherein a probability of the 2D transform type is modeled as a joint probability of the first 1D transform type and the second 1D transform type.

11. The method of claim 10, wherein the joint probability is equal to a sum of a probability of the first 1D transform type and a probability of the second 1D transform type conditioned on the first 1D transform type.

12. (canceled)

13. An apparatus, comprising:
a processor configured to:
receive a first one-dimensional (1D) transform type that forms a two-dimensional (2D) transform type;
entropy coding the first 1D transform type using context information;
receiving a second 1D transform type that forms the 2D transform type; and
entropy coding the second 1D transform type, wherein entropy coding the second 1D transform type is conditioned on the first 1D transform type.

14. The apparatus of claim 13, wherein one of:
the first 1D transform type is a 1D vertical transform type and the second 1D transform type is a 1D horizontal transform type; or
the first 1D transform type is a 1D horizontal transform type and the second 1D transform type is a 1D vertical transform type.

15. The apparatus of claim 13, wherein the 2D transform type is one transform type of 16 available transform types, and a cardinality of symbols available for entropy coding each of the first 1D transform type and the second 1D transform type is 4.

16. The apparatus of claim 13, wherein to entropy code the first 1D transform type comprises to entropy encode a first symbol representing the first 1D transform type, and to entropy code the second 1D transform type comprises to entropy encode a second symbol representing the second 1D transform type.

17. The apparatus of claim 13, wherein the processor comprises at least a portion of a hardware decoder.

18. The apparatus of claim 13, wherein to entropy code the first 1D transform type comprises to entropy decode a first variable from an encoded bitstream representing the first 1D transform type, and to entropy code the second 1D transform type comprises to entropy decode a second variable from the encoded bitstream representing the second 1D transform type.

19. The apparatus of claim 13, wherein the first 1D transform type is different from the second 1D transform type.

20. The apparatus of claim 13, wherein a probability of the 2D transform type is modeled as a joint probability of the first 1D transform type and the second 1D transform type.

21. The apparatus of claim 20, wherein the joint probability is equal to a sum of a probability of the first 1D transform type and a probability of the second 1D transform type conditioned on the first 1D transform type.
